(19) United States
(12) Patent Application Publication
(10) Pub. No.: US 2024/0334204 A1
(43) Pub. Date: Oct. 3, 2024

(54) INFORMATION TRANSMISSION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Yi XIONG, Beijing (CN); Xing YANG, Beijing (CN)

(21) Appl. No.: 18/579,248

(22) PCT Filed: Jul. 16, 2021
(86) PCT No.: PCT/CN2021/106711

§ 371 Date: Jan. 12, 2024

(51) Int. Cl. H04W 24/02

(52) U.S. Cl. CPC H04W 24/02

(57) ABSTRACT

An information transmission method is performed by a user equipment (UE), and includes: determining, through a prediction model run by the UE, a prediction result of radio resource management (RRM) according to configuration information; and reporting the prediction result to an access network device according to the configuration information.

### CROSS REFERENCE TO RELATED APPLICATION

This application is a US National Stage of International Application No. PCT/CN2021/106711, filed on Jul. 16, 2021, the content of which is incorporated by reference herein in its entirety.

### TECHNICAL FIELD

This application relates to the technical field of wireless communication but is not limited thereto, and in particular relates to an information transmission method and apparatus, a communication device and a storage medium.

### BACKGROUND

In a mobile communication system, the movement of user equipment (UE) causes the channel conditions around it to change constantly. In order to support the mobility of the UE and obtain the channel status of the current surrounding cells of the UE in a timely manner, the network configures the UE to perform radio resource management (RRM) measurement. The UE in the idle state and the inactive state autonomously performs cell selection or cell reselection based on the RRM measurement results. The UE in the connected state reports the RRM measurement results to the network, thereby assisting the network in making cell handover decisions. During the measurement process of the UE in the connected state, the network in the new radio (NR) system sends measurement configuration information to the UE in the connected state through RRC signaling, and the UE performs intra-frequency/inter-frequency/cross-radio access technology (RAT) measurement, and then report the measurement result to the network.

### SUMMARY

In view of above, embodiments of this disclosure provide an information transmission method and apparatus, a communication device and a storage medium.

According to a first aspect of the embodiments of this disclosure, an information transmission method is provided, where the method is performed by a user equipment (UE) and includes:
determining, through a prediction model run by the UE, a prediction result of RRM according to configuration information; and
reporting the prediction result to an access network device according to the configuration information.

According to a second aspect of the embodiments of this disclosure, an information transmission method is provided, where the method is performed by an access network device and includes:
sending configuration information, where the configuration information is used by a prediction model run by a UE to determine a prediction result of RRM.

According to a third aspect of the embodiments of this disclosure, a communication device is provided and includes a processor, and a memory storing an executable program by the processor, where the processor is configured to perform the information transmission method according to the first aspect or the second aspect as described.

According to a fourth aspect of the embodiments of this disclosure, there is provided a storage medium on which an executable program is stored, where the executable program is used for, upon being executed by a processor, implementing the information transmission method according to the first aspect or the second aspect as described.

It should be understood that both the foregoing general description and the following detailed description are exemplary and explanatory only, and are not intended to limit the embodiments of this disclosure.

### BRIEF DESCRIPTION OF THE DRAWINGS

The accompanying drawings, which are incorporated in and constitute a part of this specification, illustrate embodiments consistent with the present invention and together with the description serve to explain principles of some embodiments of the present invention.

FIG. 1 is a schematic structural diagram of a wireless communication system according to some embodiments.

FIG. 2 is a schematic flowchart of an information transmission method according to some embodiments.

FIG. 3 is a schematic flowchart of another information transmission method according to some embodiments.

FIG. 4 is a block diagram of an information transmission apparatus according to some embodiments.

FIG. 5 is a block diagram of another information transmission apparatus according to some embodiments.

FIG. 6 is a block diagram of a device for information transmission according to some embodiments.

### DETAILED DESCRIPTION

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementation manners described in the following exemplary embodiments do not represent all implementation manners consistent with the embodiments of this disclosure. Rather, they are merely examples of apparatuses and methods consistent with aspects of the disclosed embodiments as recited in the appended claims.

Terms used in the embodiments of this disclosure are for the purpose of describing specific embodiments only, and are not intended to limit the embodiments of this disclosure. As used in the examples of this disclosure and the appended claims, the singular forms “a/an” and “the” are also intended to include the plural forms unless the context clearly dictates otherwise. It should also be understood that the term “and/or” as used herein refers to and includes any and all possible combinations of one or more of the associated items as listed.

It should be understood that although the embodiments of this disclosure may use the terms “first”, “second”, “third”, etc. to describe various information, the information should not be limited to these terms. These terms are only used to distinguish information of the same type from one another. For example, without departing from the scope of the embodiments of this disclosure, first information may also be called second information, and similarly, second information may also be called first information. Depending on the context, the words “if” and “in case” as used herein may be interpreted as “upon” or “when” or “in response to determining that . . . ”

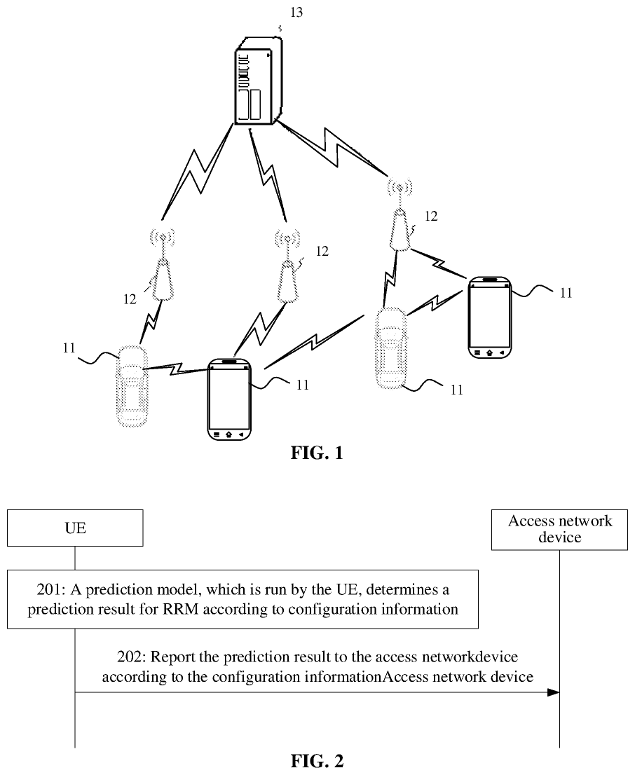

Referring to FIG. 1, it shows a schematic structural diagram of a wireless communication system according to some embodiments of this disclosure. As shown in FIG. 1, the wireless communication system is a communication system based on cellular mobile communication technology, and the wireless communication system may include several terminals 11 and several base stations 12.

Herein, the terminal 11 may be a device that provides voice and/or data connectivity to the user. The terminal 11 can communicate with one or more core networks via a radio access network (RAN), and the terminal 11 can be an Internet of Things (IoT) terminal, such as a sensor device, a mobile phone (or called a “cellular” phone) and a computer provided with an IoT terminal which, for example, may be a fixed, portable, pocket, hand-held, built-in computer or vehicle-mounted device. For example, it may be station (STA), subscriber unit, subscriber station, mobile station, mobile site, remote station, access point, remote terminal, access terminal, user terminal, user agent, user device, or user terminal (UE). Alternatively, the terminal 11 may also be a device of an unmanned aerial vehicle. Alternatively, the terminal 11 may also be a vehicle-mounted device, for example, a trip computer with a wireless communication function, or a wireless communication device connected externally to the trip computer. Alternatively, the terminal 11 may also be a roadside device, for example, it may be a street lamp, a signal lamp, or other roadside devices with a wireless communication function.

The base station 12 may be a network side device in the wireless communication system. Herein, the wireless communication system may be the 4th generation mobile communication (4G) system, also known as the long term evolution (LTE) system: or, the wireless communication system may also be the 5G system, also known as the new radio (NR) system or 5G NR system. Alternatively, the wireless communication system may also be a next-generation system of the 5G system. Herein, the access network in the 5G system may be called new generation-radio access network (NG-RAN). Alternatively, it may be a machine type communication (MTC) system.

Herein, the base station 12 may be an evolved NodeB (eNB) used in the 4G system. Alternatively, the base station 12 may also be a gNB adopting a centralized distributed architecture in the 5G system. When the base station 12 adopts the centralized distributed architecture, it generally includes a central unit (CU) and at least two distributed units (DUs). The central unit is provided with a protocol stack of a packet data convergence protocol (PDCP) layer, a radio link layer control protocol (RLC) layer, and a media access control (MAC) layer. The distributed unit is provided with a physical (PHY) layer protocol stack. The specific implementation manner of the base station 12 are not limited in the embodiments of this disclosure.

A wireless connection may be established between the base station 12 and the terminal 11 through a wireless air interface. In different embodiments, the wireless air interface may be a wireless air interface based on the 4G standard: or, the wireless air interface may be a wireless air interface based on the 5G standard, for example, the wireless air interface is a new air interface: alternatively, the wireless air interface may also be a wireless air interface based on a technical standard of a next-generation mobile communication network based on 5G.

In some embodiments, an E2E (end to end) connection may also be established between the terminals 11, for example, in some scenarios including V2V (vehicle to vehicle) communication, V2I (vehicle to Infrastructure) communication and V2P (vehicle to pedestrian) communication in the V2X (vehicle to everything) communication.

In some embodiments, the forgoing wireless communication system may further include a network management device 13.

Several base stations 12 are connected to the network management device 13 respectively. Herein, the network management device 13 may be a core network device in the wireless communication system. For example, the network management device 13 may be a mobility management entity (MME). Alternatively, the network management device may also be other core network devices, such as serving gateway (SGW), public data network gateway (PGW), policy and charging rules function (PCRF), home subscriber server (HSS), and the like. The implementation manner of the network management device 13 is not limited in the embodiments of this disclosure.

Executors involved in the embodiments of this disclosure include, but are not limited to: UEs, such as mobile phone terminals supporting cellular mobile communications, and base stations.

An application scenario of some embodiments of this disclosure is as follows. With the progress of society and economic development, users have higher and higher demands on wireless networks, and the deployment of networks has become more and more complicated. In order to adapt to this change, wireless network is also getting smarter. The rapid development of artificial intelligence (AI) technology further provides technical support for intelligent communication networks. Intelligent communication networks are already an indispensable part in daily life, so it is an inevitable trend to apply AI technology to wireless networks.

Machine learning algorithm is one of the most important implementation manners of AI technology. Machine learning can obtain modules through a large amount of training data, and events can be predicted through the modules. In many fields, the modules trained by machine learning can obtain very accurate prediction result. Network-side based AI enhancements have been studied in RAN3 and SA.

Although the AI on the network side can obtain more data, the UE can obtain more UE-side information. The AI module on the UE side is more conducive to improving user experience. On the one hand, considering personal privacy and data volume, it is impossible for the UE to report all the information to the network. On the other hand, the network will train common modules for all UEs instead of customizing AI modules for each UE. Generic modules cannot provide the best user experience. Therefore, how to deploy AI on the UE side for RRM prediction is an urgent problem to be solved.

As shown in FIG. 2, some exemplary embodiments provide an information transmission method, which may be applied to a UE in a cellular mobile communication system, and includes following steps.

In step 201, a prediction model run by the UE determines a prediction result of RRM according to configuration information.

In step 202, the prediction result is reported to an access network device according to the configuration information.

Here, the UE may be a mobile phone UE or the like that uses a cellular mobile communication technology to perform wireless communication. The access network device may be a base station or the like that provides an access network interface to the UE in the cellular mobile communication system.

The prediction model may be a machine learning model with learning capabilities, including but not limited to a neural network. The prediction model can obtain a prediction result by predicting the information associated with the RRM based on historical data and information related to RRM, such as the location of the UE, the movement information of the UE, and the like. For example, a 3-layer convolutional neural network (CNN) model may be used to predict the reference signal receiving power (RSRP), etc., to obtain a predicted RSRP value and the like.

The prediction model may be run by the UE, that is, the prediction model run by the UE itself, for example, a neural network run by the UE itself. The prediction model uses the local historical data of the UE, the information associated with RRM of the UE, and communication capabilities of the UE to make predictions. Here, the historical data may be historical data used to determine the RRM relevant measurement result, such as the corresponding relationship between historical RSRP and UE location, the corresponding relationship between historical RSRP and UE speed, and the like.

Compared with the prediction model on the network side, the prediction model on the UE side eliminates the need for the network side to store data and calculate the prediction model for each UE. Data and prediction models can be maintained locally by the UE. The UE side can train a customized AI module for the UE based on local data, so as to provide a better user experience. At the same time, for data with security requirements, the UE can complete the training of the prediction model locally rather than reporting data, thereby improving data security. The UE does not need to report the training data and the like through the wireless link, thereby reducing the wireless communication load.

Here, the prediction result may be one or more results for different prediction objects. For example, it may be various RRM relevant prediction results corresponding to different cells.

The configuration information may be used for the UE to configure the prediction result determined by the prediction model. When referring to that the UE configures the prediction model to determine the prediction result, it includes but not limited to that the UE configures the prediction model, and/or the UE configures the prediction result output by the prediction model, and the like.

Exemplarily, the UE may configure the prediction object and/or the prediction result type predicted by the prediction model according to the configuration information.

The configuration information may also be used for the UE to determine the reporting configuration of the prediction result. The reporting configuration of the prediction result includes but is not limited to: the transmission resource of the prediction result, and/or the type of the prediction result reported by the UE.

Exemplarily, the UE may determine the time domain position for reporting the prediction result according to the configuration information.

The configuration information may be preset in the UE, or may be predefined by a communication protocol, or the like.

In some embodiments, the method further includes: receiving the configuration information sent by the access network device.

Here, the network side may configure the configuration information based on requirements such as mobility management, and send it to the UE.

The prediction result is determined on the UE side, and the UE can report the prediction result to the access network device after obtaining the prediction result. The UE side may report the prediction result to the access network device based on the configuration of the configuration information. After the network side receives the prediction result, the prediction result may be used for mobility management of the UE and the like.

Exemplarily, the access network device may use radio resource control (RRC) signaling to carry configuration information, and send the configuration information to the UE.

In this way, the UE determines and sends the RRM prediction result by using the prediction model based on the configuration information. On the one hand, local data of the UE can be used to train the prediction model and determine the prediction result, so that the determined prediction result is relatively adaptive to the actual situation of the UE, thereby improving the prediction accuracy of the prediction model. On the other hand, compared to performing RRM prediction on the network side, the UE can maintain data locally without reporting data for training the prediction model and/or data for determining the prediction result, thereby improving data security and reducing wireless communication load.

In some embodiments, the configuration information includes at least one of the following:
a prediction object configuration, indicating a corresponding prediction object predicted by the prediction model run by the UE;
a reporting configuration, indicating a configuration for reporting the prediction result;
a prediction identifier, indicating the reported prediction result;
a prediction quantity configuration, indicating a configuration of the prediction result determined by the prediction model run by the UE;
a prediction start period, indicating a first time domain range of the prediction model run by the UE;
a prediction window length, indicating a second time domain range corresponding to the prediction result determined by the prediction model run by the UE;
a report result configuration, indicating a configuration of the reported prediction result; and
a model configuration, indicating the prediction model.

Here, there may be one or more prediction objects indicated by the prediction object configuration, and the prediction object may be a frequency point, a cell, and/or a beam associated with the RRM.

The configuration for reporting the prediction result indicated by the reporting configuration may include: a resource configuration and/or a reporting manner for the UE to report the prediction result. Different reporting configurations may be configured on the network side, and different reporting configurations may have unique reporting configuration identifiers. The configuration information may use different reporting configuration identifiers to indicate different reporting configurations.

The prediction identifier may be used to uniquely identify the prediction result.

The prediction quantity configuration may indicate the information content contained in the prediction result determined by the prediction model, and the like.

The prediction start period may indicate the first time domain range for the UE to run the prediction model. The UE runs the prediction model in the first time domain range.

The prediction model may predict the prediction result within the second time domain range, and the prediction window length may indicate the second time domain range. The second time domain range may be one or more time points, or one or more time periods.

The report result configuration may indicate the form and/or information content of the prediction result that the network side requires the UE to report. The reported prediction result may be the same as or different from the prediction result determined by the prediction model in terms of form and/or information content. For example, the prediction model determines the prediction result of multiple cells, but the reported prediction result may only include the prediction result of one cell.

The model configuration may indicate the prediction model adopted by the UE, configuration parameters required for running the prediction model, and the like.

In this way, the access network device can indicate, through the configuration information, relevant configuration for the UE to run the prediction model and relevant configuration for the UE to report the prediction result, so that the UE can report the prediction result required by the access network device, thereby reducing unnecessary prediction result reported by the UE to the access network device, and improving the validity of the prediction result.

In some embodiments, the prediction object configuration indicates at least one of the following:
cell;
frequency (point);
beam.

The prediction object configuration may indicate the cells that need the prediction model to determine the prediction result by means of cell identifiers and other means. For example, the prediction object configuration may indicate the UE's serving cell and/or neighbor cell. Here, the prediction object configuration may indicate the prediction object by indicating the prediction object identifier. For example, the prediction object configuration may indicate a cell by indicating a cell identifier.

The prediction object configuration may directly indicate a specific frequency point to indicate the frequency point that needs the prediction model to determine the prediction result. The identifiers corresponding to different frequency points may also be pre-agreed by the base station and the UE, and the prediction object configuration may indicate the frequency points for which the prediction model needs to determine the prediction result by indicating the identifiers corresponding to different frequency points. In this way, the access network device can explicitly indicate the prediction object, thereby reducing the blindness of the UE in selecting the prediction object, and improving the prediction efficiency.

In some embodiments, in response to the frequency point indicated by the prediction object configuration, the prediction model is configured to determine the prediction result of one or more cells using the frequency point indicated by the prediction object configuration.

Exemplarily, the prediction object is a frequency point(s), but the prediction model may need to determine the prediction result corresponding to a cell(s), so this cell(s) may refer to some or all cells of the frequency point(s) that can be detected by the UE.

The prediction object configuration may indicate the beam that needs the prediction model to determine the prediction result through beam identifiers and other means.

In some embodiments, the prediction object configuration includes at least one of the following:
a cell blacklist, including an identifier of a cell not to be predicted;
a cell whitelist, including an identifier of a cell to be predicted.

The UE may use the prediction model to determine the prediction result for all currently detected cells. The prediction object configuration may indicate a cell identifier(s) of a cell(s) that needs to be predicted, and a cell identifier(s) of a cell(s) that does not need to be predicted. In this way, the UE may not determine the prediction result for the cell(s) in the cell blacklist, thereby reducing the prediction load.

The UE may determine whether to enable the cell blacklist and/or the cell whitelist based on an indication of the access network device.

Exemplarily, the access network device may indicate to the UE whether to enable the cell blacklist and/or the cell whitelist through the reporting configuration.

In some embodiments, if the cell blacklist is configured to be used in the reporting configuration sent by the base station, the cells in the blacklist are not predicted when predicting the predicted value of the configuration type through the AI module.

In some embodiments, if the cell whitelist is configured to be used in the reporting configuration sent by the base station, only the cells in the whitelist list are predicted when predicting the predicted value of the configuration type through the AI module.

In some embodiments, the reporting configuration indicates a criterion for reporting the prediction result.

The criterion for reporting the prediction result may be a standard or rule followed by the UE to report the prediction result. The UE may send the prediction result based on certain rules.

In some embodiments, the criterion for reporting the prediction result include at least one of the following:
a period for reporting the prediction result;
a number of times for reporting the prediction result;
a trigger signaling triggering reporting of the prediction result;
a trigger event triggering reporting of the prediction result.

The UE may report the prediction result periodically. The criterion for reporting the prediction result indicated by the reporting configuration may include the period for reporting the prediction result. The UE may report based on the period indicated by the reporting configuration.

The criterion for reporting the prediction result indicated by the reporting configuration may include the number of times for reporting the prediction result. Exemplarily, the UE may set a counter, and the UE may report the prediction result periodically and stop reporting the prediction result when the counter exceeds the number of times indicated by the reporting configuration.

Reporting of the prediction result may be triggered by signaling, and the access network device may trigger the UE to send the prediction result through a triggering signaling. The criterion for reporting the prediction result indicated by the reporting configuration may include the triggering signaling for triggering the reporting of the prediction result. When the reporting configuration indicates the triggering signaling, the UE can be explicitly or implicitly indicated to at least report the prediction result in a signaling-triggered manner.

Reporting of the prediction result may also be triggered by an event. Here, the event may be a predefined triggering condition, for example, a predetermined message has been detected by the UE, the working state of the UE meets a predetermined condition, and the like. When the UE satisfies the predefined triggering condition, the prediction result is sent. The criterion for reporting the prediction result indicated by the reporting configuration may include the event for triggering the reporting of the prediction result. When the reporting configuration indicates the triggering event, the UE can be explicitly or implicitly indicated to at least report the prediction result in an event-triggered manner.

Exemplarily, the UE periodically sends the prediction result according to the configuration of the network. The criterion for periodically reporting the prediction result configured by network may include:
(1) the trigger type is “period”;
(2) the number of times of reporting is greater than 1;
(3) the reporting interval is valid, and the network sets a reporting period timer according to a configured interval parameter.

In some embodiments, the prediction identifier indicates one of prediction objects and at least one of the following having a corresponding relationship:
the reporting configuration;
the prediction quantity configuration;
the prediction start period;
the prediction window length;
the report result configuration;
a model configuration.

The prediction identifier may indicate a correspondence between a prediction object and a prediction-related configuration. The prediction-related configuration may include configurations related to the prediction model, configurations related to reporting of the prediction result, and the like. For one prediction object, at least one of the following may be configured on the network side: one reporting configuration, one prediction quantity configuration, one prediction start period, one prediction window length, one reporting result configuration, and one model configuration.

When the prediction identifier indicates a complete correspondence, the UE may use the prediction model to predict the prediction result based on the complete correspondence indicated by the prediction identifier. If the prediction identifier does not indicate a complete correspondence, for example, the prediction identifier only indicates one prediction object, then the UE will not perform prediction of the prediction result.

Exemplarily, the prediction identifier may uniquely indicate the reported prediction result. The prediction identifier associates a specific prediction object with a specific reporting configuration.

Each prediction identifier may only associate one prediction object identifier with one reporting configuration identifier. A prediction object or a reporting configuration that is not in a complete correspondence cannot be predicted by the prediction model. Only when the configuration is modified subsequently on the network side and the complete correspondence is configured, the corresponding prediction of the prediction model can be started.

Each prediction object may be associated with multiple different prediction identifiers; each reporting configuration may be associated with multiple different prediction identifiers.

In some embodiments, after a prediction identifier is deleted, the correspondence, identified by the prediction identifier, between the corresponding prediction object and reporting configuration will be terminated, but parameters themselves including the prediction object and the reporting configuration will not be deleted.

In some embodiments, when deleting a prediction object or a reporting configuration, all prediction identifiers associated therewith may need to be deleted at the same time.

In some embodiments, the prediction quantity configuration indicates a type of the prediction result determined by the prediction model run by the UE.

Here, different types of prediction result may include prediction values/parameters of the prediction model for different prediction quantities. For example, different types of prediction result may include: the lowest RSRP, the lowest reference signal receiving quality (RSRQ), the lowest signal to interference plus noise ratio (SINR), and the like of a cell.

The prediction quantity configuration may indicate one or more types of prediction result that are required to be determined by the prediction model.

The type of the prediction result reported by the UE may be selected from all types of prediction result determined by the prediction model. The UE may select one or more types to report from multiple types of prediction result determined by the prediction model.

In some embodiments, different triggering events or triggering signaling may trigger different types of prediction results.

In some embodiments, the prediction start period indicates a period for the UE to run the prediction model.

The prediction start period may be a period in which the UE allows the prediction model to perform prediction and obtain a corresponding prediction result.

In some embodiments, the UE may determine an actually used prediction period based on the prediction start period, and a minimum prediction frequency requirement may be sent from the network or the minimum prediction frequency requirement may be specified by the protocol.

The network may specify that the prediction start period is 20 s, that is, at least once every 20 s, and the UE may allow the prediction model to make a prediction every 10 s.

In some embodiments, the report result configuration indicates at least one of the following:
a format of the reported prediction result;
a type of the reported prediction result;
a cell corresponding to the reported prediction result;
a frequency point corresponding to the reported prediction result.

The UE may use a prediction model to determine different types of prediction result corresponding to different cells and/or different frequency points, and the network side may indicate the different types of prediction result corresponding to different cells and/or different frequency points that require the UE to report. The reported predication result may be the same as or different from those determined by the prediction model. The network side may indicate the format used by the UE for reporting the prediction result.

The report result configuration may indicate: the format and information content of the prediction result reported by the UE side, and the prediction result may include one or more of the following information contents:
a prediction identifier;
prediction result information of one or more cells, where the prediction result may include a cell ID and one or more prediction result.

Exemplarily, the reported prediction result may include output results and cell IDs of all or part of the cells, that need to be predicted, defined by the prediction object associated with the prediction identifier, including the output results of all or part of prediction quantities corresponding to the prediction quantity configuration.

Exemplarily, the reported prediction result may include output results and cell IDs of the cells that meet the triggering condition, including the output results of all or part of prediction quantities corresponding to the prediction quantity configuration.

Exemplarily, the reported prediction result includes output results and cell IDs of the cells with the best prediction result among all or part of the prediction quantities corresponding to the prediction quantity configuration that are optionally carried according to the reporting configuration.

Other prediction result may be obtained by the UE.

In some embodiments, the UE may also report the prediction result of a prediction quantity related to the UE's own communication characteristics included in the prediction quantity configuration.

In some embodiments, the model configuration indicates at least one of the following:
the prediction model;
a configuration parameter of the prediction model;
initial data used for training the prediction model.

The network side may determine the prediction model used by the UE to determine the prediction result, and the access network device may deliver the prediction model, for example a 3-layer CNN model or the like, through the model configuration for prediction of the prediction result. Different prediction models may be configured to determine the prediction result of one or more prediction objects and/or of different types, or the like.

The network side may also deliver, through the access network device, the configuration parameter of the prediction model, such as accuracy parameters, and the like, thereby improving the accuracy of the prediction model.

The prediction model delivered by the access network device may need to be trained before it can be actually used to predict the prediction result. The access network device may deliver the initial data for the UE to train the prediction model, so that the prediction model can complete the initial training, and then realize the determination of the prediction result.

Exemplary, the network side may send the prediction model for this UE; the network side may also send the prediction model specific to a prediction result type of a prediction object; the network side may also send the prediction model specific to the UE and the prediction result type of the prediction object.

In some embodiments, the prediction result includes at least one of the following:
a RRM prediction result of the UE;
an RRM prediction result of a serving cell where the UE is located;
an RRM prediction result of at least one neighboring cell of the UE.

The RRM prediction result may include but not limited to: an occurrence probability of high-traffic services at UE within a certain period of time; an occurrence probability of low-latency services at UE within a certain period of time; the trajectory and movement direction of UE within a certain period of time; a quality of service (QOS) requirement of UE within a certain period of time; a quality of experience (QoE) requirement of UE within a certain period of time, and the like.

The RRM prediction result of the serving cell where the UE is located may include but not limited to: an occurrence probability of radio link failure at UE within a certain period of time; an occurrence probability of interruption or call drop at UE within a certain period of time; an occurrence probability that the UE's QoS/QoE does not meet its requirement(s) within a certain period of time; a probability that the UE can continue to reside in the serving cell within a certain period of time; a possible average signal quality/peak signal quality/minimum signal quality within a certain period of time if the UE continues to reside in the serving cell, where the signal quality may include: RSRP/RSRQ/SINR; a possible average rate/peak rate/minimum rate and the like within a certain period of time if the UE continues to reside in the serving cell; a possible average transmission delay/minimum transmission delay/highest transmission delay and the like within a certain period of time if the UE continues to reside in the serving cell; and a recommendation degree to continue to reside in this serving cell obtained by taking into account various output results (including but not limited to the forgoing output results).

The RRM prediction result of at least one neighboring cell of the UE may include but not limited to: an occurrence probability of handover failure if the UE accesses this neighboring cell; an occurrence probability of ping-pong if the UE chooses to access this neighboring cell; an occurrence probability of interruption or call drop within a certain period of time if the UE accesses this neighboring cell; an occurrence probability that the QoS/QoE does not meet its requirement(s) within a certain period of time if the UE accesses this neighboring cell; a probability that the UE can continue to reside in this neighboring cell within a certain period of time if the UE accesses this neighboring cell; a possible average signal quality/peak signal quality/minimum signal quality within a certain period of time if the UE accesses this neighboring cell, where the signal quality may include RSRP/RSRQ/SINR; a possible average rate/peak rate/minimum rate within a certain period of time if the UE accesses this neighboring cell; a possible average transmission delay/minimum transmission delay/highest transmission delay within a certain period of time if the UE accesses this neighboring cell; and a recommendation degree to hand over to this neighboring cell obtained by taking into account various output results (including but not limited to the forgoing output results);

In some embodiments, the RRM prediction result of at least one neighboring cell of the UE includes:
the probability that handover failure occurs when the UE is handed over to the neighboring cell.

The prediction model may predict the occurrence probability of handover failure if the UE is handed over to the neighboring cell based on historical handover data of the UE, as well as the current location of the UE, the communication capability of the UE, and the signal quality of the neighbor cell.

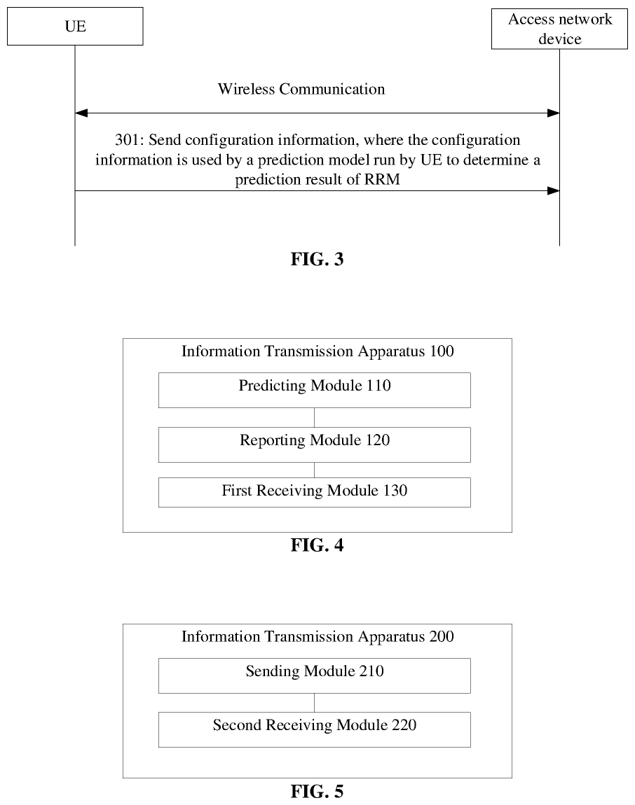

As shown in FIG. 3, some exemplary embodiments provide an information transmission method, which may be applied to an access network device of a cellular mobile communication system and includes following steps.

In step 201, configuration information is sent, where the configuration information is used for a prediction model run by the UE to determine an RRM prediction result.

Here, the UE may be a mobile phone UE or the like that uses a cellular mobile communication technology to perform wireless communication. The access network device may be a base station or the like that provides an access network interface to the UE in the cellular mobile communication system.

The first prediction model may be a machine learning model with learning capabilities, including but not limited to a neural network. The prediction model can obtain a prediction result by predicting the information associated with the RRM based on historical data and information related to RRM, such as the location of the UE, the movement information of the UE, and the like. For example, a 3-layer CNN model may be used to predict the RSRP, etc., to obtain a predicted RSRP value and the like.

The prediction model may be run by the UE, that is, the prediction model run by the UE itself, for example, a neural network run by the UE itself. The prediction model uses the local historical data of the UE, the information associated with RRM of the UE, and communication capabilities of the UE to make predictions. Here, the historical data may be historical data used to determine the RRM relevant measurement result, such as the corresponding relationship between historical RSRP and UE location, the corresponding relationship between historical RSRP and UE speed, and the like.

Compared with the prediction model on the network side, the prediction model on the UE side eliminates the need for the network side to store data and calculate the prediction model for each UE. Data and prediction models can be maintained locally by the UE. The UE side can train a customized AI module for the UE based on local data, so as to provide a better user experience. At the same time, for data with security requirements, the UE can complete the training of the prediction model locally rather than reporting the data, thereby improving data security. The UE does not need to report the training data and the like through the wireless link, thereby reducing the wireless communication load.

Here, the prediction result may be one or more results for different prediction objects. For example, it may be various RRM relevant prediction results corresponding to different cells.

The configuration information may be used for the UE to configure the prediction result determined by the prediction model. When referring to that the UE configures the prediction model to determine the prediction result, it includes but not limited to that the UE configures the prediction model, and/or the UE configures the prediction result output by the prediction model, and the like.

Exemplarily, the UE may configure the prediction object and/or the prediction result type predicted by the prediction model according to the configuration information.

The configuration information may also be used for the UE to determine the reporting configuration of the prediction result. The reporting configuration of the prediction result includes but is not limited to: the transmission resource of the prediction result, and/or the type of the prediction result reported by the UE.

Exemplarily, the UE may determine the time domain position for reporting the prediction result according to the configuration information.

The configuration information may be preset in the UE, or may be predefined by a communication protocol, or the like.

Here, the network side may configure the configuration information based on requirements of, for example, mobility management, and send the configuration information to the UE.

In some embodiments, the method further includes:
receiving the prediction result reported by the UE according to the configuration information.

The prediction result is determined on the UE side, and the UE can report the prediction result to the access network device after obtaining the prediction result. The UE side may report the prediction result to the access network device based on the configuration of the configuration information. After the network side receives the prediction result, the prediction result may be used for mobility management of the UE and the like.

Exemplarily, the access network device may use RRC signaling to carry configuration information, and send the configuration information to the UE.

In this way, the UE determines and sends the RRM prediction result by using the prediction model based on the configuration information. On the one hand, local data of the UE can be used to train the prediction model and determine the prediction result, so that the determined prediction result is relatively adaptive to the actual situation of the UE, thereby improving the prediction accuracy of the prediction model. On the other hand, compared to performing RRM prediction on the network side, the UE can maintain data locally without reporting data for training the prediction model and/or data for determining the prediction result, thereby improving data security and reducing wireless communication load.

In some embodiments, the configuration information includes at least one of the following:
a prediction object configuration, indicating a corresponding prediction object predicted by the prediction model run by the UE;
a reporting configuration, indicating a configuration for reporting the prediction result;
a prediction identifier, indicating the reported prediction result;
a prediction quantity configuration, indicating a configuration of the prediction result determined by the prediction model run by the UE;
a prediction start period, indicating a first time domain range of the prediction model run by the UE;
a prediction window length, indicating a second time domain range corresponding to the prediction result determined by the prediction model run by the UE;
a report result configuration, indicating a configuration of the reported prediction result; and
a model configuration, indicating the prediction model.

Here, there may be one or more prediction objects indicated by the prediction object configuration, and the prediction object may be a frequency point, a cell, and/or a beam associated with the RRM.

The configuration for reporting the prediction result indicated by the reporting configuration may include: a resource configuration and/or a reporting manner for the UE to report the prediction result. Different reporting configurations may be configured on the network side, and different reporting configurations may have unique reporting configuration identifiers. The configuration information may use different reporting configuration identifiers to indicate different reporting configurations.

The prediction identifier may be used to uniquely identify the prediction result.

The prediction quantity configuration may indicate the information content contained in the prediction result determined by the prediction model, and the like.

The prediction start period may indicate the first time domain range for the UE to run the prediction model. The UE runs the prediction model in the first time domain range.

The prediction model may predict the prediction result within the second time domain range, and the prediction window length may indicate the second time domain range. The second time domain range may be one or more time points, or one or more time periods.

The report result configuration may indicate the form and/or information content of the prediction result that the network side requires the UE to report. The reported prediction result may be the same as or different from the prediction result determined by the prediction model in terms of form and/or information content. For example, the prediction model determines the prediction result of multiple cells, but the reported prediction result may only include the prediction result of one cell.

The model configuration may indicate the prediction model adopted by the UE, configuration parameters required for running the prediction model, and the like.

In this way, the access network device can indicate, through the configuration information, relevant configuration for the UE to run the prediction model and relevant configuration for the UE to report the prediction result, so that the UE can report the prediction result required by the access network device, thereby reducing unnecessary prediction result reported by the UE to the access network device, and improving the validity of the prediction result.

In some embodiments, the prediction object configuration indicates at least one of the following:
cell;
frequency (point);
beam.

The prediction object configuration may indicate the cells that need the prediction model to determine the prediction result by means of cell identifiers and other means. For example, the prediction object configuration may indicate the UE's serving cell and/or neighbor cell. Here, the prediction object configuration may indicate the prediction object by indicating the prediction object identifier. For example, the prediction object configuration may indicate a cell by indicating a cell identifier.

The prediction object configuration may directly indicate a specific frequency point to indicate the frequency point that needs the prediction model to determine the prediction result. The identifiers corresponding to different frequency points may also be pre-agreed by the base station and the UE, and the prediction object configuration may indicate the frequency points for which the prediction model needs to determine the prediction result by indicating the identifiers corresponding to different frequency points. In this way, the access network device can explicitly indicate the prediction object, thereby reducing the blindness of the UE in selecting the prediction object, and improving the prediction efficiency.

In some embodiments, in response to the frequency point indicated by the prediction object configuration, the prediction model is configured to determine the prediction result of one or more cells using the frequency point indicated by the prediction object configuration.

Exemplarily, the prediction object is a frequency point(s), but the prediction model may need to determine the prediction result corresponding to a cell(s), so this cell(s) may refer to some or all cells of the frequency point(s) that can be detected by the UE.

The prediction object configuration may indicate the beam that needs the prediction model to determine the prediction result through beam identifiers and other means.

In some embodiments, the prediction object configuration includes at least one of the following:
a cell blacklist, including an identifier of a cell not to be predicted;
a cell whitelist, including an identifier of a cell to be predicted.

The UE may use the prediction model to determine the prediction result for all currently detected cells. The prediction object configuration may indicate a cell identifier(s) of a cell(s) that needs to be predicted, and a cell identifier(s) of a cell(s) that does not need to be predicted. In this way, the UE may not determine the prediction result for the cell(s) in the cell blacklist, thereby reducing the prediction load.

The UE may determine whether to enable the cell blacklist and/or the cell whitelist based on an indication of the access network device.

Exemplarily, the access network device may indicate to the UE whether to enable the cell blacklist and/or the cell whitelist through the reporting configuration.

In some embodiments, if the cell blacklist is configured to be used in the reporting configuration sent by the base station, the cells in the blacklist are not predicted when predicting the predicted value of the configuration type through the AI module.

In some embodiments, if the cell whitelist is configured to be used in the reporting configuration sent by the base station, only the cells in the whitelist list are predicted when predicting the predicted value of the configuration type through the AI module.

In some embodiments, the reporting configuration indicates a criterion for reporting the prediction result.

The criterion for reporting the prediction result may be a standard or rule followed by the UE to report the prediction result. The UE may send the prediction result based on certain rules.

In some embodiments, the criterion for reporting the prediction result by the UE include at least one of the following:
a period for reporting the prediction result by the UE;
a number of times for reporting the prediction result by the UE;
a trigger signaling triggering the UE's reporting of the prediction result;
a trigger event triggering the UE's reporting of the prediction result.

The UE may report the prediction result periodically. The criterion for reporting the prediction result indicated by the reporting configuration may include the period for reporting the prediction result. The UE may report based on the period indicated by the reporting configuration.

The criterion for reporting the prediction result indicated by the reporting configuration may include the number of times for reporting the prediction result. Exemplarily, the UE may set a counter, and the UE may report the prediction result periodically and stop reporting the prediction result when the counter exceeds the number of times indicated by the reporting configuration.

Reporting of the prediction result may be triggered by signaling, and the access network device may trigger the UE to send the prediction result through a triggering signaling. The criterion for reporting the prediction result indicated by the reporting configuration may include the triggering signaling for triggering the reporting of the prediction result. When the reporting configuration indicates the triggering signaling, the UE can be explicitly or implicitly indicated to at least report the prediction result in a signaling-triggered manner.

Reporting of the prediction result may also be triggered by an event. Here, the event may be a predefined triggering condition, for example, a predetermined message has been detected by the UE, the working state of the UE meets a predetermined condition, and the like. When the UE satisfies the predefined triggering condition, the prediction result is sent. The criterion for reporting the prediction result indicated by the reporting configuration may include the event for triggering the reporting of the prediction result. When the reporting configuration indicates the triggering event, the UE can be explicitly or implicitly indicated to at least report the prediction result in an event-triggered manner.

Exemplarily, the UE periodically sends the prediction result according to the configuration of the network. The criterion for periodically reporting the prediction result configured by network may include:
(1) the trigger type is “period”;
(2) the number of times of reporting is greater than 1;
(3) the reporting interval is valid, and the network sets a reporting period timer according to a configured interval parameter.

In some embodiments, the prediction identifier indicates one of prediction objects and at least one of the following having a corresponding relationship:
the reporting configuration;
the prediction quantity configuration;
the prediction start period;
the prediction window length;
the report result configuration;
a model configuration.

The prediction identifier may indicate a correspondence between a prediction object and a prediction-related configuration. The prediction-related configuration may include configurations related to the prediction model, configurations related to reporting of the prediction result, and the like. For one prediction object, at least one of the following may be configured on the network side: one reporting configuration, one prediction quantity configuration, one prediction start period, one prediction window length, one reporting result configuration, and one model configuration.

When the prediction identifier indicates a complete correspondence, the UE may use the prediction model to predict the prediction result based on the complete correspondence indicated by the prediction identifier. If the prediction identifier does not indicate a complete correspondence, for example, the prediction identifier only indicates one prediction object, then the UE will not perform prediction of the prediction result.

Exemplarily, the prediction identifier may uniquely indicate the reported prediction result. The prediction identifier associates a specific prediction object with a specific reporting configuration.

Each prediction identifier may only associate one prediction object identifier with one reporting configuration identifier. A prediction object or a reporting configuration that is not in a complete correspondence cannot be predicted by the prediction model. Only when the configuration is modified subsequently on the network side and the complete correspondence is configured, the corresponding prediction of the prediction model can be started.

Each prediction object may be associated with multiple different prediction identifiers: each reporting configuration may be associated with multiple different prediction identifiers.

In some embodiments, after a prediction identifier is deleted, the correspondence, identified by the prediction identifier, between the corresponding prediction object and reporting configuration will be terminated, but parameters themselves including the prediction object and the reporting configuration will not be deleted.

In some embodiments, when deleting a prediction object or a reporting configuration, all prediction identifiers associated therewith may need to be deleted at the same time.

In some embodiments, the prediction quantity configuration indicates a type of the prediction result determined by the prediction model run by the UE.

Here, different types of prediction result may include prediction values/parameters of the prediction model for different prediction quantities. For example, different types of prediction result may include: the lowest RSRP, the lowest RSRQ, the lowest SINR, and the like of a cell.

The prediction quantity configuration may indicate one or more types of prediction result that are required to be determined by the prediction model.

The type of the prediction result reported by the UE may be selected from all types of prediction result determined by the prediction model. The UE may select one or more types to report from multiple types of prediction result determined by the prediction model.

In some embodiments, different triggering events or triggering signaling may trigger different types of prediction results.

In some embodiments, the prediction start period indicates a period for the UE to run the prediction model.

The prediction start period may be a period in which the UE allows the prediction model to perform prediction and obtain a corresponding prediction result.

In some embodiments, the UE may determine an actually used prediction period based on the prediction start period, and a minimum prediction frequency requirement may be sent from the network or the minimum prediction frequency requirement may be specified by the protocol.

The network may specify that the prediction start period is 20 s, that is, at least once every 20 s, and the UE may allow the prediction model to make a prediction every 10 s.

In some embodiments, the report result configuration indicates at least one of the following:
a format of the reported prediction result;
a type of the reported prediction result;
a cell corresponding to the reported prediction result;
a frequency point corresponding to the reported prediction result.

The UE may use a prediction model to determine different types of prediction result corresponding to different cells and/or different frequency points, and the network side may indicate the different types of prediction result corresponding to different cells and/or different frequency points that require the UE to report. The reported predication result may be the same as or different from those determined by the prediction model. The network side may indicate the format used by the UE for reporting the prediction result.

The report result configuration may indicate: the format and information content of the prediction result reported by the UE side, and the prediction result may include one or more of the following information contents:
a prediction identifier;
prediction result information of one or more cells, where the prediction result may include a cell ID and one or more prediction result.

Exemplarily, the reported prediction result may include output results and cell IDs of all or part of the cells, that need to be predicted, defined by the prediction object associated with the prediction identifier, including the output results of all or part of prediction quantities corresponding to the prediction quantity configuration.

Exemplarily, the reported prediction result may include output results and cell IDs of the cells that meet the triggering condition, including the output results of all or part of prediction quantities corresponding to the prediction quantity configuration.

Exemplarily, the reported prediction result includes output results and cell IDs of the cells with the best prediction result among all or part of the prediction quantities corresponding to the prediction quantity configuration that are optionally carried according to the reporting configuration.

Other prediction result may be obtained by the UE.

In some embodiments, the UE may also report the prediction result of a prediction quantity related to the UE's own communication characteristics included in the prediction quantity configuration.

In some embodiments, the model configuration indicates at least one of the following:
the prediction model;
a configuration parameter of the prediction model;
initial data used for training the prediction model.

The network side may determine the prediction model used by the UE to determine the prediction result, and the access network device may deliver the prediction model, for example a 3-layer CNN model or the like, through the model configuration for prediction of the prediction result. Different prediction models may be configured to determine the prediction result of one or more prediction objects and/or of different types, or the like.

The network side may also deliver, through the access network device, the configuration parameter of the prediction model, such as accuracy parameters, and the like, thereby improving the accuracy of the prediction model.

The prediction model delivered by the access network device may need to be trained before it can be actually used to predict the prediction result. The access network device may deliver the initial data for the UE to train the prediction model, so that the prediction model can complete the initial training, and then realize the determination of the prediction result.

Exemplary, the network side may send the prediction model for this UE: the network side may also send the prediction model specific to a prediction result type of a prediction object; the network side may also send the prediction model specific to the UE and the prediction result type of the prediction object.

In some embodiments, the prediction result includes at least one of the following:
a RRM prediction result of the UE;
an RRM prediction result of a serving cell where the UE is located;
an RRM prediction result of at least one neighboring cell of the UE.

The RRM prediction result may include but not limited to: an occurrence probability of high-traffic services at UE within a certain period of time; an occurrence probability of low-latency services at UE within a certain period of time; the trajectory and movement direction of UE within a certain period of time; a quality of service (QOS) requirement of UE within a certain period of time; a quality of experience (QoE) requirement of UE within a certain period of time, and the like.

The RRM prediction result of the serving cell where the UE is located may include but not limited to: an occurrence probability of radio link failure at UE within a certain period of time; an occurrence probability of interruption or call drop at UE within a certain period of time; an occurrence probability that the UE's QoS/QoE does not meet its requirement(s) within a certain period of time; a probability that the UE can continue to reside in the serving cell within a certain period of time; a possible average signal quality/peak signal quality/minimum signal quality within a certain period of time if the UE continues to reside in the serving cell, where the signal quality may include: RSRP/RSRQ/SINR; a possible average rate/peak rate/minimum rate and the like within a certain period of time if the UE continues to reside in the serving cell; a possible average transmission delay/minimum transmission delay/highest transmission delay and the like within a certain period of time if the UE continues to reside in the serving cell; and a recommendation degree to continue to reside in this serving cell is obtained by taking into account various output results (including but not limited to the forgoing output results).

The RRM prediction result of at least one neighboring cell of the UE may include but not limited to: an occurrence probability of handover failure if the UE accesses this neighboring cell; an occurrence probability of ping-pong if the UE chooses to access this neighboring cell; an occurrence probability of interruption or call drop within a certain period of time if the UE accesses this neighboring cell; an occurrence probability that the QoS/QoE does not meet its requirement(s) within a certain period of time if the UE accesses this neighboring cell; a probability that the UE can continue to reside in this neighboring cell within a certain period of time if the UE accesses this neighboring cell; a possible average signal quality/peak signal quality/minimum signal quality within a certain period of time if the UE accesses this neighboring cell, where the signal quality may include RSRP/RSRQ/SINR; a possible average rate/peak rate/minimum rate within a certain period of time if the UE accesses this neighboring cell; a possible average transmission delay/minimum transmission delay/highest transmission delay within a certain period of time if the UE accesses this neighboring cell; and a recommendation degree to hand over to neighboring cell this is obtained by taking into account various output results (including but not limited to the forgoing output results);

In some embodiments, the RRM prediction result of at least one neighboring cell of the UE includes the probability that handover failure occurs when the UE is handed over to the neighboring cell.

The prediction model may predict the occurrence probability of handover failure if the UE is handed over to the neighboring cell based on historical handover data of the UE, as well as the current location of the UE, the communication capability of the UE, and the signal quality of the neighbor cell.

A specific example is provided below in combination with any of the forgoing embodiments.

Compared with the AI of the network, the AI module, that is, the prediction model, on the UE side eliminates the need for the network to store data and perform calculations on the prediction model for each UE. Data and prediction models can be maintained locally by the UE, so there are no personal safety concerns. The UE can train a customized prediction model for the UE based on local data, so as to provide better user experience.

The specific scheme for the UE to run the prediction model to obtain the prediction result is as follows.

1. The UE obtains the prediction result of the UE-side prediction model according to the configuration information of the network and sends the prediction result to the network.

2. The prediction result of the UE-side prediction model described in 1 may be one or more prediction result for different prediction objects and prediction quantities.

3. The configuration information of the network mentioned in 1 may include but not limited to one or more of the following information:
3.1. prediction object configuration;
3.2. reporting configuration;
3.3. prediction identifier;
3.4. prediction quantity configuration;
3.5. prediction start cycle;
3.6. prediction window length;
3.7, report result configuration;
3.8. model configuration.

4. The prediction object described in 3.1 defines the object to be predicted,

including the prediction object identifier (ID) and specific configuration of the corresponding prediction target.
4.1. The frequency points or cells that need to be predicted are defined in the prediction object.
4.2. Blacklist cells and whitelist cells may also be defined in the prediction object.
   4.2.1. In some embodiments, if the cell blacklist is enabled in the reporting configuration sent by the base station, the cells in the blacklist are not predicted when predicting the predicted value of the configuration type through the prediction model.
   4.2.2. In some embodiments, if the cell whitelist is enabled in the prediction reporting configuration sent by the base station, only the cells in the whitelist are predicted when predicting the predicted value of the configuration type through the AI module.

5. The reporting configuration described in 3.2 defines the reporting criterion, including the reporting configuration identifier and the specific configuration of the corresponding criterion. According to the reporting criterion, it may be divided into:
5.1. periodically triggered reporting, where the corresponding reporting configuration includes reporting period and reporting times;
5.2. one-time triggered report, where the corresponding reporting configuration includes report triggering signaling;
5.3. event-based triggered reporting.

6. For the periodic triggering of the UE to report the prediction result of the AI described in 5, the UE periodically sends the prediction result of the prediction model according to the configuration of the network. The criterion configured by the network for periodically reporting the prediction result of the prediction model includes:
(1) the trigger type is “period”;
(2) the number of times of reporting is greater than 1;
(3) the reporting interval is valid, and the network sets a reporting period timer according to a configured interval parameter.

7. For the once-triggered UE's reporting of the prediction result of the prediction model described in 5, the UE triggers reporting of the prediction result of the corresponding prediction model according to the triggering signaling sent by the network, and the UE reports the prediction result of the prediction model after receiving this signaling.

8. The prediction identifier mentioned in 3.3 is a single ID that associates a specific prediction object with a specific reporting configuration.
8.1. In some embodiments, each prediction identifier may only associate one prediction object identifier with one reporting configuration identifier.
8.2. In some embodiments, prediction objects or reporting configurations that are not in a complete association relationship cannot be predicted by the prediction model. Subsequently, only when the network side modifies the prediction configuration and configures a complete association relationship for it can the corresponding predication of the prediction model be started.
8.3. In some embodiments, each prediction object or each reporting configuration may be associated with a different prediction identifier.
8.4. In some embodiments, after the prediction identifier is deleted, the association identified by it between the corresponding prediction object and the reporting configuration will be terminated, but parameters themselves including the prediction object and the reporting configuration will not be deleted.
8.5. In some embodiments, when deleting a prediction object or a reporting configuration, all prediction identifiers associated with it may need to be deleted at the same time.

9. The prediction quantity configuration described in 3.4 may include one or more types of prediction result.
9.1. In some embodiments, the triggering event described in 8 may be configured according to the type of prediction result contained in the prediction quantity configuration, and different events may trigger different types of prediction result.
9.2. In some embodiments, the prediction quantity reported by the UE may be selected from the prediction quantity configuration, and one or more prediction results may be selected as the prediction result reported by the UE.

10. The prediction start period described in 3.5 is the start period for the UE-side prediction model described in 1 to perform prediction and obtain the prediction result of the corresponding prediction model.

In some embodiments, the prediction start period may be determined by the UE, and a minimum prediction frequency requirement may be sent from the network or the minimum prediction frequency requirement may be specified by the protocol.

11. The prediction window length described in 3.6 is the time information of the prediction model, including the time window configuration.

12. The report result configuration described in 3.7 includes the format and content of the prediction result of the prediction model reported by the UE, which may include one or more of the following information:
a prediction identifier;
prediction result information of one or more cells, where the prediction result may include a cell ID, one or more prediction quantities and corresponding prediction result of the prediction model.
12.2.1. In some embodiments, the reported prediction result includes output results and cell IDs of all or part of the cells, that need to be predicted, defined by the prediction object associated with the prediction identifier, including the output results of all or part of the prediction quantities.
12.2.2. In some embodiments, the reported prediction result information includes the output results and cell IDs of the cells that meet the trigger conditions, including all or part of the prediction results corresponding to the prediction quantity configuration.
12.2.3. In some embodiments, the reported prediction result includes output results and cell IDs of the cells with the best prediction result among all or part of the prediction quantities corresponding to the prediction quantity configuration that are optionally carried according to the reporting configuration.
12.3. Other prediction result that may be obtained by the UE.
12.3.1. In some embodiments, the UE may also report the prediction result of prediction quantity related to the UE's own characteristic included in the prediction quantity configuration.

13. The model configuration in 3.8 includes but is not limited to one or more of the following information:
13.1. initial values sent by the network side for training the UE-side prediction model;
13.2. a general prediction model sent by the network.
Example: 3-layer CNN model.
13.3. a dedicated prediction model sent by the network terminal;
a prediction model specific to this UE sent by the network;
a prediction model, sent by the network, specific to the prediction quantity in this prediction object;
a prediction model, sent by the network side, specific to this UE and the prediction quantity in this prediction object.

14. The prediction quantity, that is, the type of the prediction result of the predicted model, may include but not limited to one or more of the following information:
the first type includes prediction models of UE about its own characteristics:
   14.1. an occurrence probability of high-traffic services at UE within a certain period of time;
   14.2. an occurrence probability of low-latency services at UE within a certain period of time;
   14.3. the trajectory and movement direction of UE within a certain period of time;
   14.4. the QoS requirements of the UE within a certain period of time;
   14.5. the QoE requirements of the UE within a certain period of time,
the second type includes prediction models about the UE's continued residing in the serving cell:
   14.6. an occurrence probability of radio link failure at UE within a certain period of time;
   14.7. an occurrence probability of interruption or call drop at UE within a certain period of time;
   14.8. an occurrence probability that the UE's QoS/QoE does not meet its requirement(s) within a certain period of time;
   14.9. a probability that the UE can continue to reside in the serving cell within a certain period of time;
   14.10. a possible average signal quality/peak signal quality/minimum signal quality within a certain period of time if the UE continues to reside in the serving cell, where the signal quality may include: RSRP/RSRQ/SINR;
   14.11. a possible average rate/peak rate/minimum rate within a certain period of time if the UE continues to reside in the serving cell;
   14.12. a possible average transmission delay/minimum transmission delay/highest transmission delay within a certain period of time if the UE continues to reside in the serving cell;
   14.13. a recommendation degree of continuing to reside in this serving cell obtained by taking into account various output results (including but not limited to the forgoing output results),
the third type includes prediction models of the UE's performance after accessing a certain neighboring cell:
   14.14. an occurrence probability of handover failure if the UE accesses this neighboring cell;
   14.15. an occurrence probability of ping-pong if the UE chooses to access this neighboring cell;
   14.16. an occurrence probability of interruption or call drop within a certain period of time if the UE accesses this neighboring cell;
   14.17. an occurrence probability that the QoS/QoE does not meet its requirement(s) within a certain period of time if the UE accesses this neighboring cell;
   14.18. a probability that the UE can continue to reside in this neighboring cell within a certain period of time if the UE accesses this neighboring cell;
   14.19. a possible average signal quality/peak signal quality/minimum signal quality within a certain period of time if the UE accesses this neighboring cell, where the signal quality may include RSRP/RSRQ/SINR;
   14.20. a possible average rate/peak rate/minimum rate within a certain period of time if the UE accesses this neighboring cell;
   14.21. a possible average transmission delay/minimum transmission delay/highest transmission delay within a certain period of time if the UE accesses this neighboring cell;
   14.22. a recommendation degree to hand over to this neighboring cell obtained by taking into account various output results (including but not limited to the forgoing output results).

15. The certain period of time in 14 may be determined through the time window configuration in the prediction window length described in 3, or may be determined according to the protocol or according to the UE implementation.

16. The prediction result of the prediction model in 1 may be obtained according to a UE-side AI module, UE characteristics, historical information stored in the UE, and the like.

Following is an embodiment taking periodic triggering as an example, which describes the triggering process of reporting the prediction result of the prediction model.

The UE is triggered to periodically report the measurement result of the UE-side prediction model.

I. The network configures the UE to periodically trigger the UE to report the prediction result of the prediction model, and the configuration information includes:
1) prediction object;
   a) cells to be predicted are the serving cell A and neighboring cells B and C,
2) reporting configuration;
   a) the triggering type is “period”;
   b) the number of reporting times is 4;
   c) the reporting interval is 10 s,
3) prediction identifier:
   the prediction ID is PID1, and PID1 associates the prediction object described in 1) with the reporting configuration described in 2),
4) the prediction quantity configuration includes: a predicted minimum RSRP of the UE in the serving cell within a given time window, and a predicted minimum RSRP within a given time window if the UE accesses a neighboring cell;
5) the prediction start period;
   the minimum start requirement configured by the network is running once per 5 s,
6) the prediction window length;
   the time window configuration: 10 s,
7) the report result configuration.
   the report prediction identifier, the predicted minimum RSRP of the UE in the serving cell within the given time window, and the predicted minimum RSRP within the given time window if the UE accesses th neighboring cells A, B and C.

II. When the UE receives the reporting configuration from the network, the report counter is set as 0.

III. The latest prediction result of the prediction model is selected; within the next 10 s, the predicted minimum RSRP of the UE in this serving cell is 5 dbm and the predicted minimum RSRPs of the UE accessing neighboring cells A, B and C within the next 10 s are 2 dbm, 1 dbm, and 2.5 dbm respectively. The reported content includes: within the next 10 s, the predicted minimum RSRP of the UE in this serving cell is 5 dbm, and the predicted minimum RSRPs of the UE accessing neighboring cells A, B and C within the next 10 s are 2 dbm, 1 dbm, and 2.5 dbm respectively.

IV. The reporting counter is added with one, and it is compared whether the reporting counter is less than the number of reporting times; if yes, step V is continued; otherwise the reporting process ends.

V. The reporting period timer T=10 s, and when the reporting period timer times out, step III is repeated.

Some embodiments of this disclosure further provide an information transmission apparatus, which is applied to a wireless communication UE. As shown in FIG. 4, the information transmission apparatus 100 includes:
a predicting module 110, configured to determine, through the prediction model run by the UE, the RRM prediction result according to the configuration information; and
a reporting module 120, configured to report the prediction result to the access network device according to the configuration information.

In some embodiments, the configuration information includes at least one of:
a prediction object configuration, indicating a corresponding prediction object predicted by the prediction model run by the UE;
a reporting configuration, indicating a configuration for reporting the prediction result;
a prediction identifier, indicating the reported prediction result;
a prediction quantity configuration, indicating a configuration of the prediction result determined by the prediction model run by the UE;
a prediction start period, indicating a first time domain range of the prediction model run by the UE;
a prediction window length, indicating a second time domain range corresponding to the prediction result determined by the prediction model run by the UE;
a report result configuration, indicating a configuration of the reported prediction result;
a model configuration, indicating the prediction model.

In some embodiments, the prediction object configuration indicates at least one of:
a cell;
a frequency point.

In some embodiments, the prediction object configuration includes at least one of:
a cell blacklist, including an identifier of a cell not to be predicted;
a cell whitelist, including an identifier of a cell to be predicted.

In some embodiments, the reporting configuration indicates a criterion for reporting the prediction result.

In some embodiments, the criterion for reporting the prediction result includes at least one of:
a period for reporting the prediction result;
a number of times for reporting the prediction result;
a trigger signaling triggering reporting of the prediction result;
a trigger event triggering reporting of the prediction result.

In some embodiments, the prediction identifier indicates one of the prediction objects and at least one of following in a correspondence:
the reporting configuration;
the prediction quantity configuration;
the prediction start period;
the prediction window length;
the report result configuration;
a model configuration.

In some embodiments, the prediction quantity configuration indicates a type of the prediction result determined by the prediction model run by the UE.

In some embodiments, the prediction start period indicates a period for running the prediction model run by the UE.

In some embodiments, the report result configuration indicates at least one of:
a format of the reported prediction result;
a type of the reported prediction result;
a cell corresponding to the reported prediction result;
a frequency point corresponding to the reported prediction result.

In some embodiments, the model configuration indicates at least one of:
the prediction model;
a configuration parameter of the prediction model;
initial data used for training the prediction model.

In some embodiments, the prediction result includes at least one of:
a prediction result of RRM of the UE;
a prediction result of RRM of a serving cell where the UE is located;
a prediction result of RRM of at least one neighboring cell of the UE.

In some embodiments, the prediction result of RRM of the at least one neighboring cell of the UE includes:
a probability that handover failure occurs when the UE is handed over to the neighboring cell.

In some embodiments, the apparatus further includes:
a first receiving module 130, configured to receive the configuration information sent by the access network device.

Some embodiments of this disclosure provide an information transmission apparatus, which is applied to an access network device for wireless communication. As shown in FIG. 5, the information transmission apparatus 200 includes:
a sending module 210, configured to send configuration information, where the configuration information is used for the prediction model run by the UE to determine the RRM prediction result.

In some embodiments, the configuration information includes at least one of:
a prediction object configuration, indicating a corresponding prediction object predicted by the prediction model run by the UE;
a reporting configuration, indicating a configuration for reporting the prediction result by the UE;
a prediction identifier, indicating the prediction result reported by the UE;
a prediction quantity configuration, indicating a configuration of the prediction result determined by the prediction model run by the UE;
a prediction start period, indicating a first time domain range of the prediction model run by the UE;
a prediction window length, indicating a second time domain range corresponding to the prediction result determined by the prediction model run by the UE;
a report result configuration, indicating a configuration of the prediction result reported by the UE;
a model configuration, indicating the prediction model.

In some embodiments, the prediction object configuration indicates at least one of:
a cell;
a frequency point.

In some embodiments, the prediction object configuration includes at least one of:
a cell blacklist, including an identifier of a cell not to be predicted;
a cell whitelist, including an identifier of a cell to be predicted.

In some embodiments, the reporting configuration indicates a criterion for reporting the prediction result by the UE.

In some embodiments, the criterion for reporting the prediction result by the UE includes at least one of:
a period for reporting the prediction result by the UE;
a number of times for reporting the prediction result by the UE;
a trigger signaling triggering the UE's reporting of the prediction result;
a trigger event triggering the UE's reporting of the prediction result.

In some embodiments, the prediction identifier indicates one of the prediction objects and at least one of following in a correspondence:
the reporting configuration;
the prediction quantity configuration;
the prediction start period;
the prediction window length;
the report result configuration;
a model configuration.

In some embodiments, the prediction quantity configuration indicates a type of the prediction result determined by the prediction model run by the UE.

In some embodiments, the prediction start period indicates a period for running the prediction model by the UE.

In some embodiments, the report result configuration indicates at least one of:
a format of the reported prediction result;
a type of the reported prediction result;
a cell corresponding to the reported prediction result;
a frequency point corresponding to the reported prediction result.

In some embodiments, the model configuration indicates at least one of:
the prediction model;
a configuration parameter of the prediction model;
initial data used for training the prediction model.

In some embodiments, the prediction result includes at least one of:
a prediction result of RRM of the UE;
a prediction result of RRM of a serving cell where the UE is located;
a prediction result of RRM of at least one neighboring cell of the UE.

In some embodiments, the prediction result of RRM of the at least one neighboring cell of the UE includes: a probability that handover failure occurs when the UE is handed over to the neighboring cell.

In some embodiments, the apparatus further includes:
a second receiving module 220, configured to receive the prediction result reported by the UE according to the configuration information.

In some exemplary embodiments, the predicting module 110, the reporting module 120, the first receiving module 130, the sending module 210 and the second receiving module 220 may be implemented by one or more central processing units (CPU), graphics processing unit (GPU), baseband processor (BP), application specific integrated circuit (ASIC), DSP, programmable logic device (PLD), complex programmable logic device (CPLD), field programmable gate array (FPGA), general processor, controller, micro controller unit (MCU), microprocessor, or other electronic components, so as to implement the aforementioned method(s).

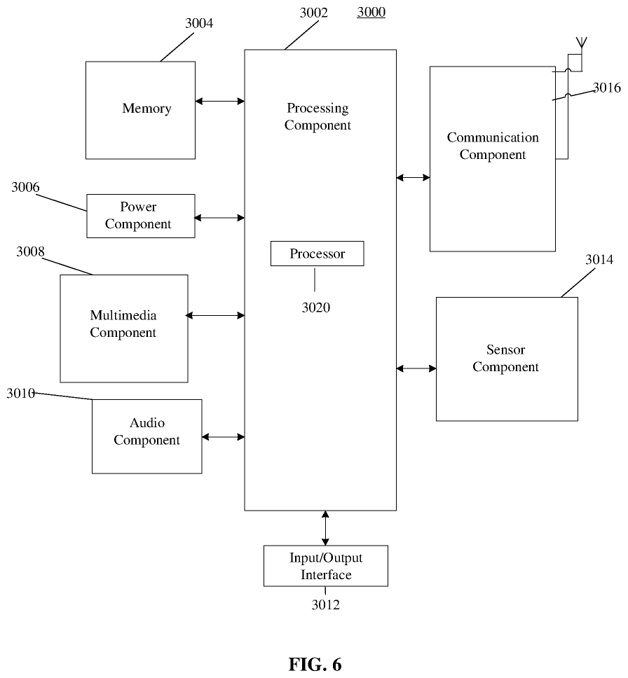

FIG. 6 is a block diagram of a device 3000 for information transmission according to some embodiments. For example, the device 3000 may be a mobile phone, a computer, a digital broadcast terminal, a messaging device, a game console, a tablet device, a medical device, a fitness device, a personal digital assistant, and the like.

Referring to FIG. 6, the device 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operation of the device 3000, such as operations associated with display, phone calls, data communications, camera operations, and recording operations. The processing component 3002 may include one or more processors 3020 to execute instructions to perform all or some of the steps of the methods described above. Additionally, the processing component 3002 may include one or more modules that facilitate interaction between the processing component 3002 and other components. For example, the processing component 3002 may include a multimedia module to facilitate interaction between the multimedia component 3008 and the processing component 3002.

The memory 3004 is configured to store various types of data to support operation at the device 3000. Examples of such data include instructions, contact data, phonebook data, messages, pictures, videos, and the like for any application or method operating on the device 3000. The memory 3004 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 3006 provides power to various components of the device 3000. The power components 3006 may include a power management system, one or more power sources, and other components associated with generating, managing, and distributing power to the device 3000.

The multimedia component 3008 includes a screen that provides an output interface between the device 3000 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 3008 includes a front camera and/or a rear camera. When the device 3000 is in an operation mode, such as a shooting mode or a video mode, the front camera and/or the rear camera may receive external multimedia data. Each of the front and rear cameras may be a fixed optical lens system or have focal length and optical zoom capability.

The audio component 3010 is configured to output and/or input audio signals. For example, the audio component 3010 includes a microphone (MIC) that is configured to receive external audio signals when the device 3000 is in operating modes, such as calling mode, recording mode, and voice recognition mode. The received audio signal may be further stored in the memory 3004 or transmitted via the communication component 3016. In some embodiments, the audio component 3010 also includes a speaker for outputting audio signals.

The I/O interface 3012 provides an interface between the processing component 3002 and a peripheral interface module, which may be a keyboard, a click wheel, a button, or the like. These buttons may include, but are not limited to: home button, volume buttons, start button, and lock button.

The sensor assembly 3014 includes one or more sensors for providing status assessments of various aspects of the device 3000. For example, the sensor assembly 3014 can detect the open/closed state of the device 3000, the relative positioning of components, such as the display and keypad of the device 3000. The sensor assembly 3014 can also detect a change in the position of the device 3000 or a component of the device 3000, the presence or absence of user contact with the device 3000, the orientation or acceleration/deceleration of the device 3000, and the temperature change of the device 3000. The sensor assembly 3014 may include a proximity sensor configured to detect the presence of nearby objects in the absence of any physical contact. The sensor assembly 3014 may also include a light sensor, such as a CMOS or CCD image sensor, for use in imaging applications. In some embodiments, the sensor assembly 3014 may also include an acceleration sensor, a gyroscope sensor, a magnetic sensor, a pressure sensor, or a temperature sensor.

The communication component 3016 is configured to facilitate wired or wireless communication between the device 3000 and other devices. The device 3000 may access wireless networks based on communication standards, such as WiFi, 2G or 3G, or a combination thereof. In some embodiments, the communication component 3016 receives broadcast signals or broadcast related information from an external broadcast management system via a broadcast channel. In some embodiments, the communication component 3016 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the device 3000 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the above method.

In some embodiments, there is also provided a non-transitory computer-readable storage medium including instructions, such as the memory 3004 including instructions, executable by the processor 3020 of the device 3000 to perform the method described above. For example, the non-transitory computer-readable storage medium may be ROM, random access memory (RAM), CD-ROM, magnetic tape, floppy disk, optical data storage device, and the like.

Other embodiments of this disclosure will readily occur to those skilled in the art upon consideration of the specification and practice of the invention disclosed herein. This application is intended to cover any variations, uses, or adaptations of this disclosure that follow the general principles of this disclosure and include common knowledge or techniques in the technical field not disclosed by this disclosure. The specification and examples are to be regarded as exemplary only, with the true scope and spirit of the disclosure being indicated by the following claims.

It is to be understood that this disclosure is not limited to the precise structures described above and illustrated in the accompanying drawings, and that various modifications and changes may be made without departing from the scope thereof. The scope of this disclosure is limited only by the appended claims.

1. An information transmission method, performed by a user equipment (UE), comprising:
determining, through a prediction model run by the UE, a prediction result of radio resource management (RRM) according to configuration information; and
reporting the prediction result to an access network device according to the configuration information.

2. The method according to claim 1, wherein the configuration information comprises at least one of:
a prediction object configuration, indicating a corresponding prediction object predicted by the prediction model;
a reporting configuration, indicating a configuration for reporting the prediction result;
a prediction identifier, indicating the prediction result;
a prediction quantity configuration, indicating a configuration of the prediction result;
a prediction start period, indicating a first time domain range of the prediction model run by the UE;
a prediction window length, indicating a second time domain range corresponding to the prediction result;
a report result configuration, indicating a configuration of the prediction result; or
a model configuration, indicating the prediction model.

3. The method according to claim 2, wherein the prediction object configuration indicates at least one of:
a cell;
a frequency point;
a cell blacklist, comprising an identifier of a cell not to be predicted; or
a cell whitelist, comprising an identifier of a cell to be predicted.

4. (canceled)

5. The method according to claim 2, wherein the reporting configuration indicates a criterion for reporting the prediction result, and the criterion for reporting the prediction result comprises at least one of:
a period for reporting the prediction result;
a number of times for reporting the prediction result;
a trigger signaling triggering reporting of the prediction result; or
a trigger event triggering reporting of the prediction result.

6. (canceled)

7. The method according to claim 2, wherein,
the prediction identifier indicates the prediction objects object and at least one of following in a correspondence:
the reporting configuration;
the prediction quantity configuration;
the prediction start period;
the prediction window length;
the report result configuration; or
a model configuration.

8. The method according to claim 2, wherein,
the prediction quantity configuration indicates a type of the prediction result; or
the prediction start period indicates a period for running the prediction model run by the UE.

9. (canceled)

10. The method according to claim 2, wherein the report result configuration indicates at least one of:
a format of the prediction result;
a type of the prediction result;
a cell corresponding to the prediction result; or
a frequency point corresponding to the prediction result.

11. The method according to claim 2, wherein the model configuration indicates at least one of:
the prediction model;
a configuration parameter of the prediction model; or
initial data used for training the prediction model.

12. The method according to claim 1, wherein the prediction result comprises at least one of:
a prediction result of RRM of the UE;
a prediction result of RRM of a serving cell where the UE is located; or
a prediction result of RRM of a neighboring cell of the UE, wherein the prediction result of RRM of the neighboring cell of the UE comprises a probability that handover failure occurs when the UE is handed over to the neighboring cell.

13. (canceled)

14. (canceled)

15. An information transmission method, performed by an access network device, comprising:
sending configuration information, wherein the configuration information is used by a prediction model run by a user equipment (UE) to determine a prediction result of radio resource management (RRM).

16. The method according to claim 15, wherein the configuration information comprises at least one of:
a prediction object configuration, indicating a corresponding prediction object predicted by the prediction model;
a reporting configuration, indicating a configuration for reporting the prediction result by the UE;
a prediction identifier, indicating the prediction result reported by the UE;
a prediction quantity configuration, indicating a configuration of the prediction result;
a prediction start period, indicating a first time domain range of the prediction model run by the UE;
a prediction window length, indicating a second time domain range corresponding to the prediction result;
a report result configuration, indicating a configuration of the prediction result reported by the UE; or
a model configuration, indicating the prediction model.

17. The method according to claim 16, wherein the prediction object configuration indicates at least one of:
a cell;
a frequency point;
a cell blacklist, comprising an identifier of a cell not to be predicted; or
a cell whitelist, comprising an identifier of a cell to be predicted.

18. (canceled)

19. The method according to claim 16, wherein the reporting configuration indicates a criterion for reporting the prediction result by the UE, and the criterion for reporting the prediction result by the UE comprises at least one of:
a period for reporting the prediction result by the UE;
a number of times for reporting the prediction result by the UE;
a trigger signaling triggering the UE's reporting of the prediction result; or
a trigger event triggering the UE's reporting of the prediction result.

20. (canceled)

21. The method according to claim 16, wherein,
the prediction identifier indicates one of the prediction objects object and at least one of following in a correspondence:
the reporting configuration;
the prediction quantity configuration;
the prediction start period;
the prediction window length;
the report result configuration; or
a model configuration.

22. The method according to claim 16, wherein,
the prediction quantity configuration indicates a type of the prediction result; or
the prediction start period indicates a period for running the prediction model by the UE.

23. (canceled)

24. The method according to claim 16, wherein the report result configuration indicates at least one of:
a format of the prediction result;
a type of the prediction result;
a cell corresponding to the prediction result; or
a frequency point corresponding to the prediction result.

25. The method according to claim 16, wherein the model configuration indicates at least one of:
the prediction model;
a configuration parameter of the prediction model; or
initial data used for training the prediction model.

26. The method according to claim 15, wherein the prediction result comprises at least one of:
a prediction result of RRM of the UE;
a prediction result of RRM of a serving cell where the UE is located; or
a prediction result of RRM of a neighboring cell of the UE, wherein the prediction result of RRM of the neighboring cell of the UE comprises a probability that handover failure occurs when the UE is handed over to the neighboring cell.

27.-34. (Canceled)

35. A user equipment (UE), comprising:
a processor; and
a memory storing instructions executable by the processor,
wherein the processor is configured to:
determine, through a prediction model run by the UE, a prediction result of radio resource management (RRM) according to configuration information; and
report the prediction result to an access network device according to the configuration information.

36. An access network device, comprising:
a processor; and
a memory storing instructions executable by the processor,
wherein the processor is configured to perform the method according to claim 15.
